(19) United States
(12) Patent Application Publication
(10) Pub. No.: US 2006/0062413 A1
(43) Pub. Date: Mar. 23, 2006

(54) Wired exercise garment and method

(76) Inventor: Michael A. Wehrell, Tampa, FL (US)

Correspondence Address: D. Joseph English;Duane Morris LLP, Suite 700, 1667 K Street, N.W., Washington, DC, 20006, US

(21) Appl. No.: 10/944,039

(22) Filed: Sep. 20, 2004

(51) Int. Cl. H04R 9/06; H04R 1/02

(52) U.S. Cl. 381/333; 381/301; 381/388

(57) ABSTRACT

An exercise garment and system of obtaining access to audio while exercising, the garment carrying an electrical cable removably connected to an earphone and an audio source carried by the person exercising. Methods are also disclosed.

### BACKGROUND OF THE INVENTION

The present invention relates to an exercise garment wired for a personal audio source.

It has become a common practice for those engaged in strenuous exercise to listen to a personal source of audio while exercising. Such sources typically include a tape or disc player, perhaps a radio receiver, adapted to be mounted to the persons arm, carried in a pocket in the garment, or hooked to the person's belt. One or more earphone or speaker is provided to be worn by the person exercising so as not to disturb others nearby, and the earphone is operably connected to the audio source by a length of wire or cable. Examples of such known devices are illustrated in FIGS. 1-3.

As shown in FIGS. 1 and 2, an extended length audio cable 20 is provided to ensure that wearers have ample cable length to reach from an arm mounted audio source 22 to the ear phones 24. Typically, a male audio jack 26 is used to provide the electrical connection to a female receptacle (not shown) in the audio source 22. As shown in FIG. 3, wearing the audio source 22 on a belt or the waistband of the athletic shorts tends to keep the cable to the rear of the person but may result in a longer loop.

One of the problems associated with such personal audio sources is the length of the cable connecting the source to the earphones. Manufacturer's typically provide a generous length of cable because they do not know the size of the individual purchaser or where such purchaser will physically locate the source on his body waist. Moreover, they may be considerable arm movement while exercising and the cable must be of sufficient length to permit a change in the relative location between the source and the earphones.

As will be apparent from FIGS. 1-3, it is possible to get the hand tangled in the cord or on objects being passed, resulting in pulling the earphones off the head or disconnecting the cable from the audio source. Injury may result from the failure of the cable to disconnect. The weight of the cord itself, and the inertia during exercise, may be sufficient to cause the cable to disconnect. The movement of the cable, particularly when wearing a sleeveless garment, may cause chaffing of the arms or in the shoulder area. Thus, any significant length of unsecured cable presents both an inconvenience and a safety hazard to the person exercising and to those nearby while jogging along a bike path, riding a bicycle, or using a piece of stationary exercise equipment such as a treadmill, bicycle, stair climber or the like.

One approach to solving this loose audio cable problem has been to replace the earphones with speakers carried by the exerciser on his person, typically fixed to a harness or a garment worn by the exerciser proximate to the chest or shoulder of the exercising person. Examples of such devices are shown, for example, in the Sato U.S. Pat. No. 4,539,700 dated Sep. 3, 1985, in the Waldron U.S. Pat. No. 4,589,134 dated May 13, 1986, the Ekman U.S. Pat. No. 4,764,962 dated Aug. 16, 1988, the Jennings U.S. Pat. No. 4,825,471 dated May 2, 1989, and the Suzuki U.S. Pat. No. 4,876,724 dated Oct. 24, 1989. Such known devices do not serve the need of exercisers in that the audio is broadcast rather than delivered only to the exerciser, are unacceptable in an outdoor environment where there may be significant ambient noise, and are unacceptable, for example, in the environment of a gym where the exercise equipment is closely packed together.

Is it accordingly an object of the present invention to obviate many of the problems associated with known personal audio systems for those engaged in strenuous exercise and to provide a novel method and exercise garment for use in a personal audio system while strenuously exercising.

Many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1 is a pictorial view of a known personal audio system where the audio source is worn on the arm and is connected to earphones by a cable.

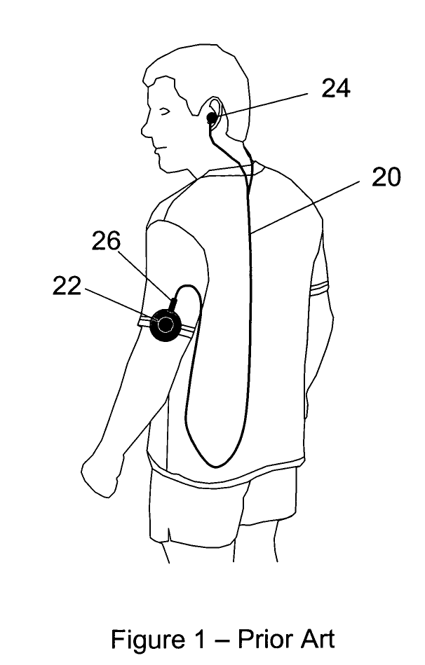

FIG. 2 is a pictorial view of the known personal audio system of FIG. 1 with the wearer engaged in exercise.

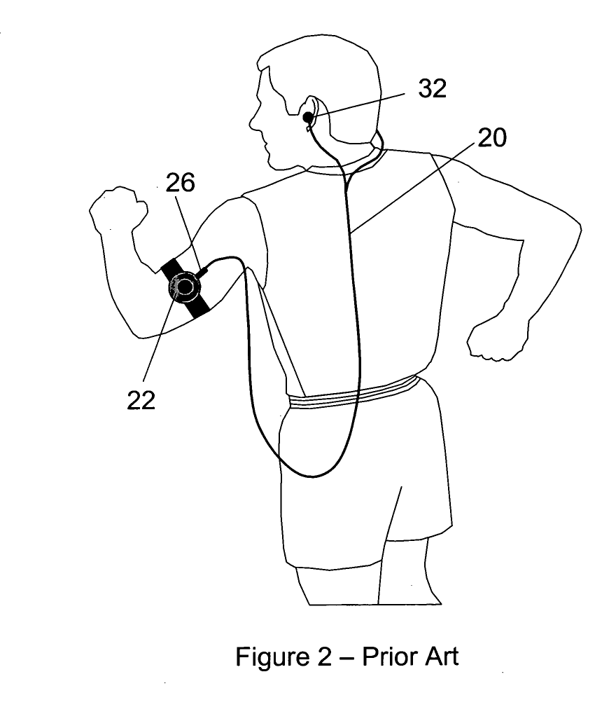

FIG. 3 is a pictorial view of a known personal audio system where the audio is worn at the waist and is connected to earphones by a cable.

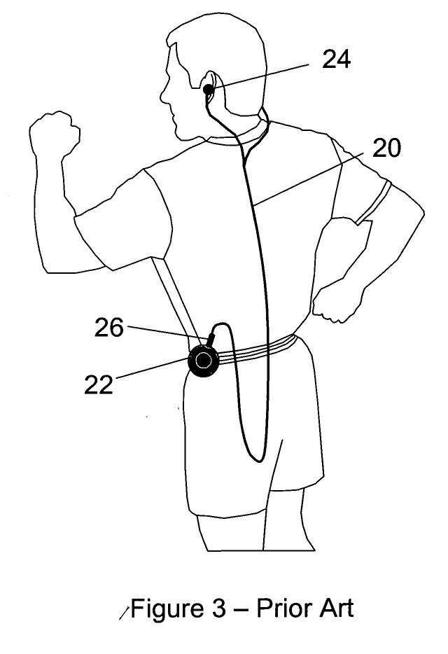

FIG. 4 is a pictorial view of a sleeved embodiment of the present invention adapted for connection to an arm worn audio source at the sleeve;

FIG. 5 is a pictorial view of a sleeved embodiment of the present invention adapted for connection to an arm worn audio source at the shoulder;

FIG. 6 is a pictorial view of a sleeveless embodiment of the present invention adapted for connection to an arm worn audio source;

FIG. 7 is a pictorial view of a sleeved embodiment of the present invention adapted for connection to an arm worn audio source at the sleeve;

FIG. 8 is a pictorial view of an embodiment of the present invention adapted for connection to the earphones in the front of the garment;

FIG. 9 is a pictorial view of an embodiment of a detachable cable of the present invention;

FIG. 10 is a pictorial view of a waist length embodiment of the present invention adapted for external connection to an audio source;

FIG. 11 is a pictorial view of an embodiment of the present invention illustrating the embedding of the cable in the seams of the garment;

FIG. 12 is a pictorial view of an over-the-waist embodiment of the present invention adapted for internal connection to an audio source;

FIG. 13 is a pictorial view of the embodiment of FIG. 12 as worn illustrating the embedding of the cable along the seams of the garment;

FIG. 14 is a pictorial view of a bare midriff embodiment of the present invention with an earphone connection in the front to the neck opening and the source connection at the arm opening; and

FIG. 15 is a pictorial view of a sleeveless bare midriff embodiment of the present invention illustrating the earphone connection on the front of the garment in a decorative or source indication.

### DESCRIPTION OF PREFERRED EMBODIMENTS

With reference to the figures where like elements have been given like numerical designations to facilitate an understanding of the present invention, a number of embodiments of the physical training apparatus of the present invention are described.

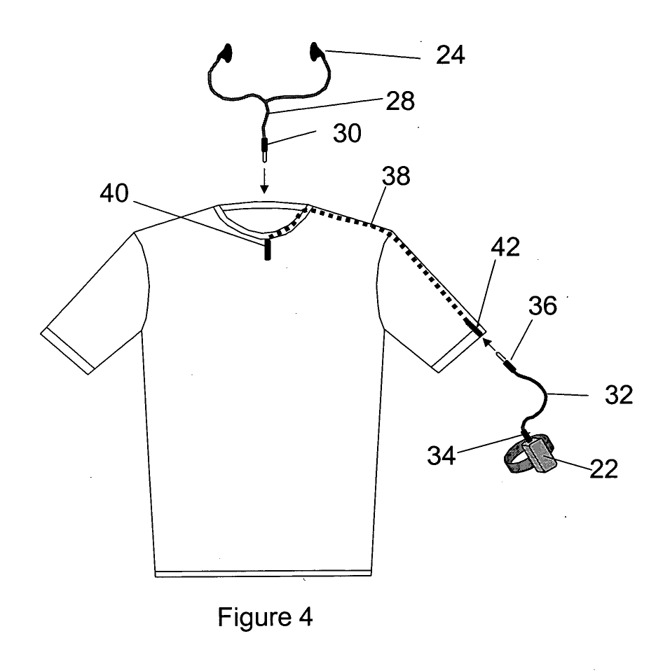

In the embodiment of FIGS. 4-7, two short cables are provided, one cable 28 being connected to the earphones 24 and having a male audio jack 30 and a second cable 32 having a male jack 34 for insertion into the receptacle (not shown) of the audio source 22 and a male jack 36 on the other end.

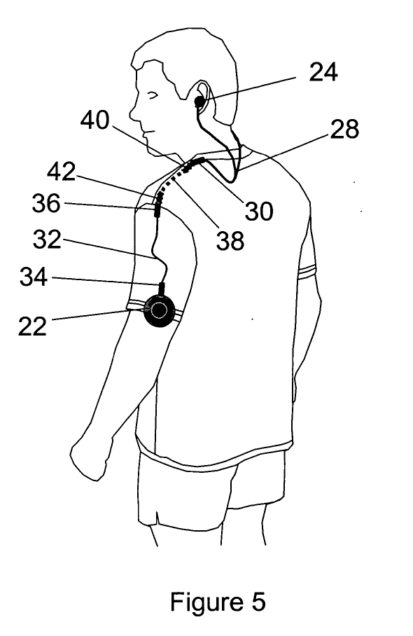

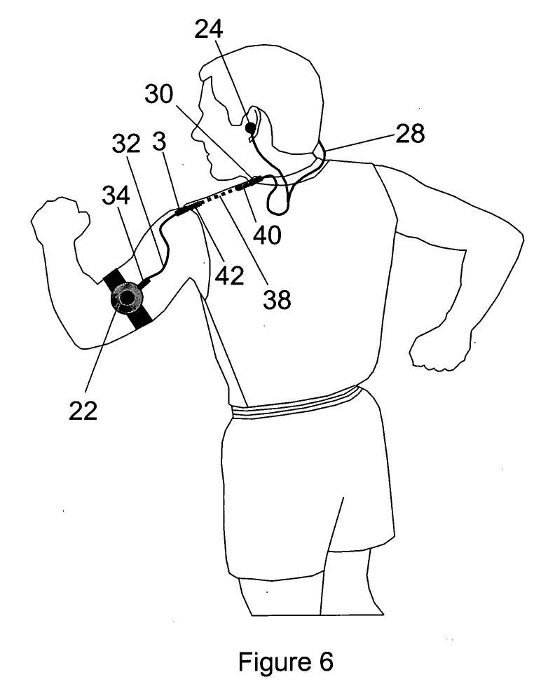

As shown in FIGS. 4-7 and 10-15, a length of cable 38 may be embedded in, or attached to, the fabric of the garment in any suitable conventional way and extend between a female receptacle 40 proximate to the neck opening of the garment and a female receptacle 42 proximate to the arm opening of the garment. Note that the location of the receptacle 42 may vary from the distal end of a sleeved garment illustrated in FIGS. 4, 7 and 14 to the shoulder of the sleeved garment shown in FIG. 5 and the sleeveless garment illustrated in FIG. 6.

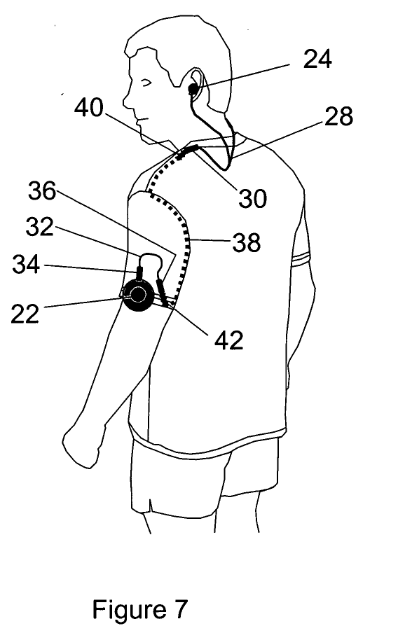

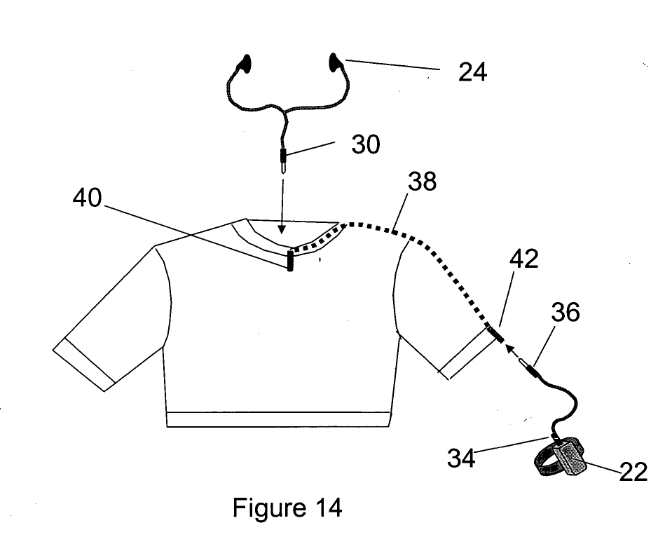

As shown in FIGS. 4 and 14, the cable 38 may be located along the shoulder seam of the garment and the upper part of the garment sleeve. Alternatively, and as shown in FIG. 7, the cable 38 may be located along a garment sleeve. In addition the garment may be provided with a pocket to receive and retain the audio source thereby eliminating the need to secure the audio source to the arm.

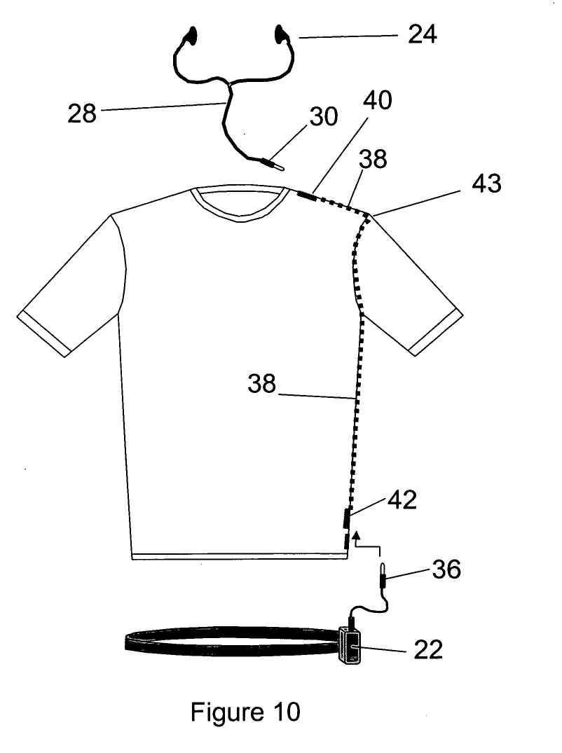

As a matter of ease in illustration only, the embedded cable is shown only on one side of the garment. However, it is to be understood that the embedded cable may alternatively be located on the right side of the garment. While only one cable internal of the shirt is shown in these and the other figures, it is also to be understood that cables may be provided on both sides to provide alternative connections as may be favored by right or left handed exercisers. Where two cables are provided, they may connect to individual or a common female jack adjacent the neck opening. Two source connectors may be provided, e.g., one at the arm opening and one at the torso opening, to give the wearer an option as to where to wear the source on his body (See, FIG. 10).

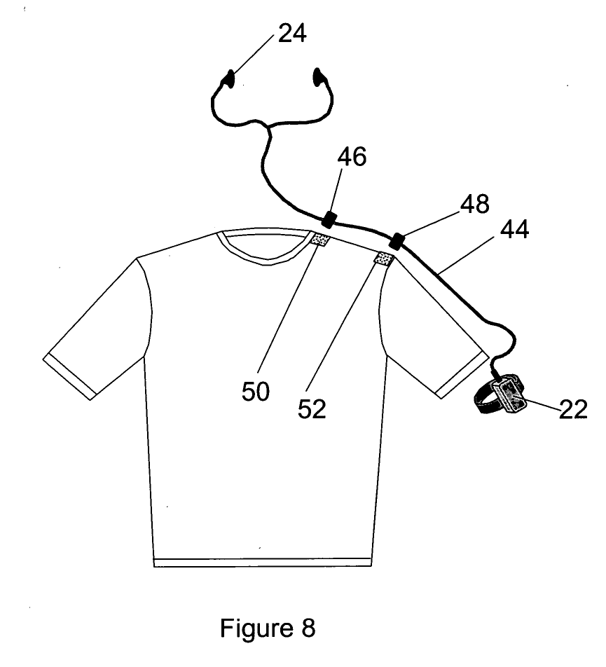

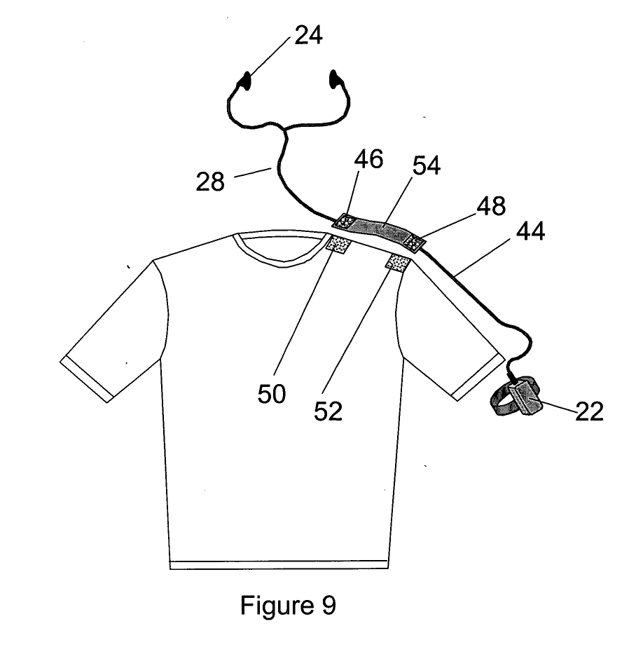

As shown in the embodiments of FIGS. 8 and 9, the use of a headphone jack may be obviated by attaching the cable to the garment rather than embedding it within the fabric of the garment. As shown in FIG. 8, the cable 44 may be continuous between the audio source 22 and the earphones 24, but desirably shortened and provided with spaced apart fabric connectors 46, 48 such as the hook/loop connectors marketed as VELCRO®. These connectors may removably connected to connectors 50, 52 permanently attached to the garment along the shoulder seam.

As shown in FIG. 9, the garment may be provided with the spaced apart connectors 50, 52 and the connectors 46, 48 attached to a flexible container 54 or envelop suitable for receiving and retaining any length of cable 44 in excess to that needed for the size of the wearer. In this way, a portion of the length of cable conventionally provided with headsets 24 may be retained within the container 54 on the wearer's shoulder to constrain the extra length and reduce the likelihood of entanglement and injury associated with a free cable during exercise.

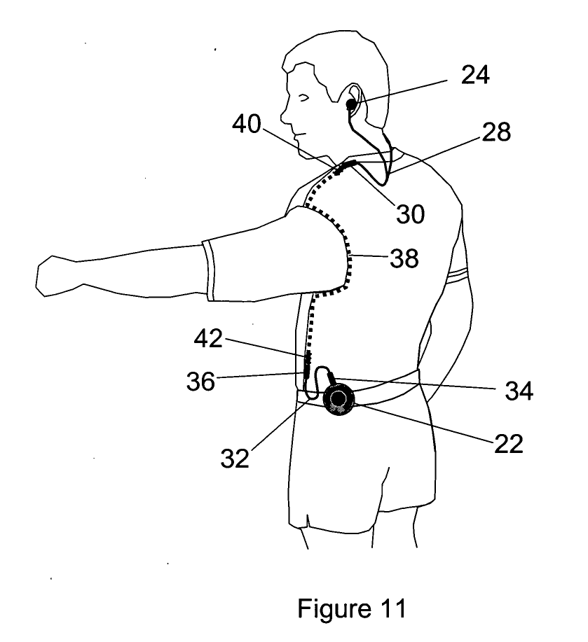

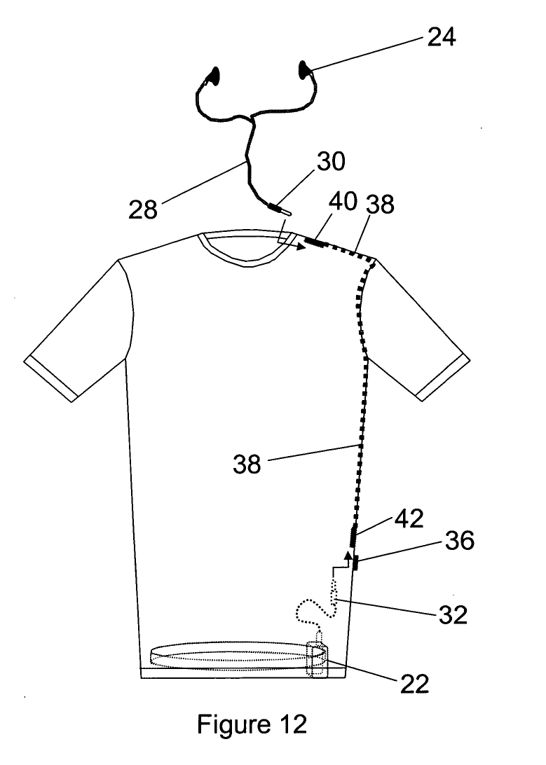

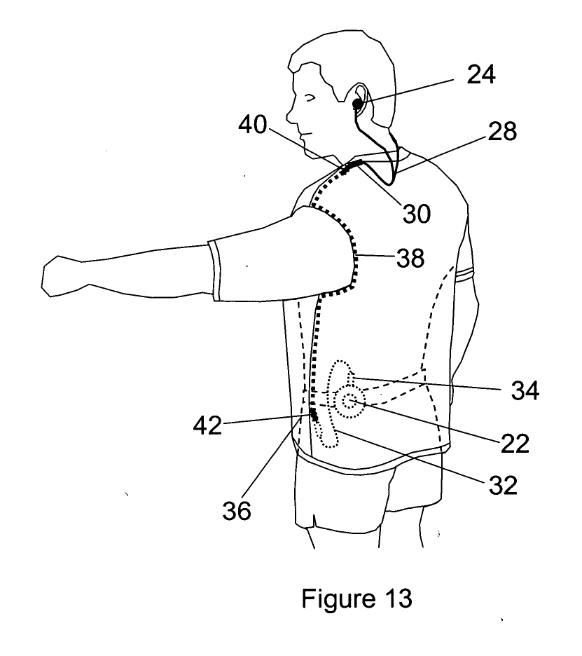

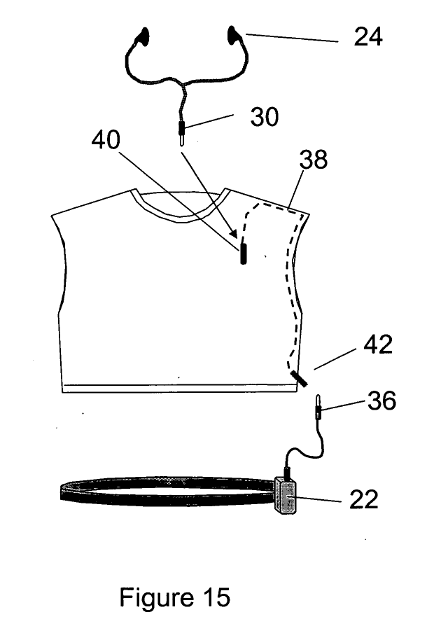

With reference to FIGS. 10, 11 and 15, the cable 38 may be embedded in the garment along the shoulder seam, around the front sleeve seam (FIGS. 10, 12 and 15) or the rear sleeve seem (FIGS. 7, 11 and 13). As shown in FIGS. 10, 12, 13 and 15, the cable may extend down the side of the garment to a jack proximate to the waist opening, for both sleeved and sleeveless garments (FIGS. 10 and 11) as well as for garments that terminate above (FIGS. 14 and 15) or below (FIGS. 12 and 13) the waist. Where it is desirable that the garment extends below the waist so as to hide the audio source 22 from view, the female receptacle 42 may be made accessible from the inside of the garment as shown in FIGS. 12 and 13. With the exception of the neck area, this eliminates the exposure of the cable to snags.

Where the female receptacle 42 is on the inside of the garment, the garment may be provided with a small slit through which the cable to the audio source may pass. This gives a user wearing the audio source 22 on their waist the option of having the garment tucked, or not tucked, into their shorts.

Note that the earphone receptacle 40 may be on the back of the neck opening, but is desirably on the side of the neck opening (FIGS. 5-7 and 11-13) or in the front of the neck opening (FIGS. 4 and 14). Alternatively as shown in FIG. 15, the earphone receptacle 40 may be located on the front of the garment, e.g. under a logo or other ornamental design element so that the garment may be worn without disclosing its potential for use with an audio source.

### ADVANTAGES AND SCOPE OF INVENTION

In various embodiments, the present invention reduces the likelihood of entanglement of an audio cable around the hand or on exercise equipment when exercising and provides support for the audio cable so that the weight thereof bouncing while running is less likely to effect a disconnect or to yank the earphones out of the ears of the person exercising. The likelihood of chaffing from movement of the cable against the body is reduced to the extent the cable is secured to the garment.

The cable itself may be reduced in length, and thus in weight, reducing tension on the earphones and allowing a full range of motion of the neck and both arms with a significant reduction in the probability of cord entanglement around surrounding objects.

The cable restraining means selectively attached to the garment allows the user to restrain a cable with excessive length.

The connection of the earphones to the front of the garment, e.g., under a logo, may be desirable because the connection may be hidden permitting the garment to be worn in social as well as exercise environments. The connection to the front of the garment rather than the rear thereof facilitates access and thus the connection of the audio source to the garment by the wearer thereof.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. An exercise garment to be worn by a person desiring to listen to an audio signal from a selected audio source carried by the person and supplied to earphones worn by the person while strenuously exercising, the garment being made of a sweat absorbing material, being sized to substantially cover the torso of the exercising person and having a neck opening, two arm openings, and a torso opening,
said garment having a first electrical connector in the general vicinity of said neck opening in position to be removably connected to the cable operatively connected to a earphone when said earphone is carried by the body of the person adjacent to such person's ear;
said garment having a second electrical connector in the vicinity of one or more of neck and torso garment openings in position to be removably connected to the cable operatively connected to an audio source carried by the person; and
an electrical cable interconnecting said first and second connectors so that a person wearing the garment may, after donning said garment, removably operably connect an earphone to said first connector and removably connect an audio source to said second connector so that such person may listen through the earphone to the audio from the attached source without disturbing other persons in the vicinity and without substantial risk of entanglement of the cable connection between the source and the earphone with other persons, equipment or structure at the exercise site.

2. The exercise garment of claim 1 wherein said first connector is located adjacent said neck opening.

3. The exercise garment of claim 2 wherein said first connector is located adjacent said neck opening at the rear thereof so that the earphone cable will be rearward of the person exercising.

4. The exercise garment of claim 2 wherein said first connector is located adjacent said neck opening at the front thereof so as to facilitate connections while the garment is being worn.

5. The exercise garment of claim 2 wherein said first connector is located on the front of the garment in the general vicinity of the person's collar bone.

6. The exercise garment of claim 5 wherein said first connector is located proximate to a decorative feature of the garment so that the visibility of said first conductor is reduced and said garment may be worn other than as an exercise garment.

7. The exercise garment of claim 2 wherein said first connector is located adjacent said neck opening at the side thereof.

8. The exercise garment of claim 1 wherein said second connector is located adjacent one of said arm openings

9. The exercise garment of claim 1 wherein said second connector is located adjacent said torso opening at the side thereof.

10. The exercise garment of claim 9 wherein said second connector is accessible internally of said garment.

11. The exercise garment of claim 9 wherein said second connector is accessible externally of said garment.

12. The exercise garment of claim 1 wherein said garment has short sleeves.

13. The exercise garment of claim 1 wherein said garment is sleeveless.

14. The exercise garment of claim 1 wherein the torso opening of said garment is above the waist so that the cable operatively connected to the source is exposed.

15. The exercise garment of claim 1 wherein the torso opening of said garment is below the waist so that the cable operatively connected to the source is hidden by said garment.

16. The exercise garment of claim 1 wherein said cable is embedded in the garment.

17. The exercise garment of claim 16 wherein said cable is carried by said garment adjacent the seams thereof.

18. The exercise garment of claim 1 wherein said cable is removably attached to the outside of said garment generally along the shoulder thereof.

19. The exercise garment of claim 18 wherein said cable includes an enclosure for receiving and retaining the portion of said cable in excess of the length needed to operatively connect said first and second connectors.

20. The exercise garment of claim 1 wherein said first connector is located on one side of said neck opening and including a third connector located on the opposite side of said neck opening from said first connector so that the person wearing the garment may select the side of the garment on which to operatively connect the earphone

21. The exercise garment of claim 1 wherein said second connector is located on one of said arm and torso openings and including a third connector located on the other of said arm and torso openings so that the person wearing the garment may select the location to which to operatively connect the source.

22. An sleeveless and bare midriff exercise garment made of a perspiration absorbing material to be worn by a person desiring to listen to an audio signal from a selected audio source carried by the person and supplied to earphones worn by the person while strenuously exercising,
said garment having a first electrical connector located on the front of the garment in the general vicinity of the person's collar bone proximate to a decorative feature of the garment so that the visibility of said first conductor is reduced and said garment may be worn other than as an exercise garment.

23. An exercise garment made of a perspiration absorbing material to be worn by a person desiring to listen to an audio signal from a selected audio source carried by the person and supplied to earphones worn by the person while strenuously exercising, said garment having sleeves and the torso opening below the waist of the wearer,
said garment having a first electrical connector located adjacent the neck opening of the garment in position to be removably connected to the cable operatively connected to a earphone when said earphone is carried by the body of the exercising person adjacent to such person's ear,
said garment having a second electrical connector in the vicinity of the waist thereof, said second connector being accessible from inside said garment in position to be removably connected to a cable operatively connected to an audio source when carried by the person proximate to the person's waist; and
an electrical cable interconnecting said first and second connectors so that a person wearing the garment may, after donning said garment, removably operable connect an earphone to said first connector and removably connect an audio source to said second connector so that such person may listen through the earphone to the audio from the attached source without disturbing other persons in the vicinity and without substantial risk of entanglement of the cable connection between the source and the earphone with other persons, equipment or structure at the exercise site.

24. A short sleeve exercise garment made of a perspiration absorbing material to be worn by a person desiring to listen to an audio signal from a selected audio source carried by the person and supplied to earphones worn by the person while strenuously exercising,
said garment having a first electrical connector located adjacent the neck opening of the garment in position to be removably connected to the cable operatively connected to a earphone when said earphone is carried by the body of the exercising person adjacent to such person's ear,
said garment having a second electrical connector carried by one of said sleeves and being accessible from outside said garment in position to be removably connected to a cable operatively connected to an audio source when carried by the person's arm; and
an electrical cable embedded in said garment and interconnecting said first and second connectors so that a person wearing the garment may, after donning said garment, removably operably connect an earphone to said first connector and removably connect an audio source to said second connector so that such person may listen through the earphone to the audio from the attached source without disturbing other persons in the vicinity and without substantial risk of entanglement of the cable connection between the source and the earphone with other persons, equipment or structure at the exercise site.

25. A short sleeve exercise garment made of a perspiration absorbing material to be worn by a person desiring to listen to an audio signal from a selected audio source carried by the person and supplied to earphones worn by the person while strenuously exercising,
said garment having a first electrical connector in position to be removably connected to the cable operatively connected to a earphone when said earphone is carried by the body of the exercising person adjacent to such person's ear,
said garment having a second electrical connector located proximate to the torso opening of said garment in position to be removably connected to a cable operatively connected to an audio source when carried by the person's arm; and
an electrical cable embedded in said garment and interconnecting said first and second connectors so that a person wearing the garment may, after donning said garment, removably operably connect an earphone to said first connector and removably connect an audio source to said second connector so that such person may listen through the earphone to the audio from the attached source without disturbing other persons in the vicinity and without substantial risk of entanglement of the cable connection between the source and the earphone with other persons, equipment or structure at the exercise site.

26. A personal audio system for a person engaged in strenuous exercise and desiring to listen to an audio signal from a selected audio source carried by the person and supplied to earphones worn by the person while strenuously exercising, said system comprising:
a garment of a perspiration absorbing material having a first mechanical connector located on the shoulder thereof;
an earphone having an electrical cable terminating in a first connector adapted to be operably connecting to a source of audio, said cable having a second mechanical connector operably mating with said first mechanical connector to removably secure said cable to said garment so that a person may operatively connect said earphone to a source of audio secured to the arm of the person exercising and listen through the earphone to the audio from the attached source without disturbing other persons in the vicinity and without substantial risk of entanglement of the cable connection between the source and the earphone with other persons, equipment or structure at the exercise site.

27. The system of claim 26 where said first and second mechanical connectors are VELCRO®.

28. The system of claim 26 including an enclosure carried by said cable for receiving and retaining a selected portion of said cable so that cable in excess of the length needed for the person to wear said earphone and connect to the source to thereby reduce the likelihood of entanglement of the cable with other persons, equipment or structure at the exercise site.

29. An earphone for a person engaged in strenuous exercise and desiring to listen to an audio signal from a selected audio source carried by the person while strenuously exercising comprising:
an earphone;
an electrical cable operably connected to said earphone at one end and terminating at the other end in a first connector adapted to be operably connecting to a source of audio carried by the person exercising; and
a mechanical connector adapted to removably secure said cable to an exercise garment made of a perspiration absorbing material,
so that a person may operatively connect said earphone to a source of audio secured to the person exercising and listen through the earphone to the audio from the attached source without disturbing other persons in the vicinity and without substantial risk of entanglement of the cable connection between the source and the earphone with other persons, equipment or structure at the exercise site.

30. The system of claim 29 where said first and second mechanical connectors are VELCRO®.

31. The system of claim 29 including an enclosure carried by said cable for receiving and retaining a selected portion of said cable so that cable in excess of the length needed for the person to wear said earphone and connect to the source to thereby reduce the likelihood of entanglement of the cable with other persons, equipment or structure at the exercise site.

32. A method of accessing a source of audio while exercising comprising the steps of:
a) donning an exercise garment having an embedded cable and two connectors, one of said connectors being carried by said garment in position for operative connection to an earphone and the other of said connectors being carried by said garment in position for operative connection to a source of audio;
b) attaching an audio source to the body of the exerciser;
c) attaching the audio source to the other one of the connectors;
d) attaching an earphone to the one of the connectors; and
e) attaching the earphone to the body of the exerciser.

33. A method of obtaining access to audio while exercising comprising the steps of:
a) donning an exercise garment;
b) attaching to the garment the cable of an earphone;
c) attaching an audio source to the body;
d) operably connecting the cable to the audio source; and
e) attaching an earphone to the body.

34. The method of claim 33 wherein the length of the cable is greater than the distance needed to operably connect to the source; and including the further steps of gathering the excess length of cable and removably securing such gathered excess cable to the garment.
